(19) United States
(12) Patent Application Publication
(10) Pub. No.: US 2019/0343317 A1
(43) Pub. Date: Nov. 14, 2019

(54) SYSTEMS AND METHODS FOR STORING PRODUCTS DROPPED OFF BY UNMANNED VEHICLES AND FOR RETRIEVING THE PRODUCTS THEREFROM

(71) Applicant: Walmart Apollo, LLC, Bentonville, AR (US)

(72) Inventors: Robert L. Cantrell, Herndon, VA (US); John J. O'Brien, Farmington, AR (US)

(21) Appl. No.: 16/270,922

(22) Filed: Feb. 8, 2019

Related U.S. Application Data
(60) Provisional application No. 62/670,244, filed on May 11, 2018.

(51) Int. Cl. A47G 29/14; A47G 29/20; G07C 9/00

(52) U.S. Cl. CPC A47G 29/141; A47G 29/20; G07C 9/00563; A47G 2029/149; G07C 9/00912; A47G 2029/145; A47G 2029/147; G07C 9/00571

(57) ABSTRACT

In some embodiments, a receptacle for receiving products dropped off by unmanned vehicles includes a movable cover configured to permit the products to enter the first storage compartment of the receptacle. The first storage compartment includes an access opening that permits a customer to retrieve the package therefrom. The first storage receptacle is separated from a second storage compartment of the receptacle by a release panel movable from a closed position that retains the package in the first storage compartment to an open position that releases the package from the first storage compartment into the second storage compartment. The release panel moves from the closed position to the open position after a predefined interval of time of the package being retained in the first storage compartment without being retrieved by the customer. The second storage compartment includes an opening that permits a delivery service operator to retrieve the package therefrom.

### CROSS-REFERENCE TO RELATED APPLICATIONS

This application claims the benefit of U.S. Provisional Application No. 62/670,244, filed May 11, 2018, which is incorporated herein by reference in its entirety.

### TECHNICAL FIELD

This invention relates generally to delivering products ordered by consumers via unmanned vehicles and, in particular, to systems and methods of storing packages dropped off by unmanned vehicles in receptacles and for dispensing the packages from the receptacles.

### BACKGROUND

An increasing number of retail providers is considering product delivery using unmanned vehicles (e.g., unmanned aerial vehicles (UAVs), unmanned ground vehicles (AGVs), etc.). The unmanned vehicles may deliver products to the homes of the customers and drop off the products onto the customer's driveway, front yard, and/or porch. Such deliveries are associated with the risk of the dropped off packages being stolen while the customer is not home. The unmanned vehicles may also deliver products to secured locations (e.g., delivery lockers, kiosks, etc.) located near the customer's home, enabling the customer to stop by the pick-up location and retrieve the delivered products from the delivery locker or kiosk by entering an access code provided in advance to the consumer. Conventional delivery lockers and kiosks rely on a complicated physical structure and are controlled by complicated electronic/computer systems. Such delivery lockers and kiosks are expensive to install and therefore may not be economically feasible to install in many communities.

### BRIEF DESCRIPTION OF THE DRAWINGS

Disclosed herein are embodiments of systems, apparatuses and methods pertaining to receiving packages containing products ordered by customers in receptacles and for dispensing the packages from the receptacles. This description includes drawings, wherein:

FIG. 1 is a diagram of a system for receiving, from unmanned vehicles, packages containing products ordered by customers in receptacles and for dispensing the packages from the receptacles in accordance with some embodiments.

FIG. 2 is a front perspective view of an exemplary receptacle in accordance with several embodiments, shown with the access panel of the first storage compartment open;

FIG. 3 is a front perspective view of an exemplary receptacle in accordance with some embodiments, shown with the access panel of the second storage compartment open;

FIG. 4 is a functional diagram of an exemplary control unit usable with the system of FIG. 1 in accordance with some embodiments; and

FIG. 5 is a flow chart diagram of a method of receiving packages containing products ordered by customers in receptacles and for dispensing the packages from the receptacles in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth.

### DETAILED DESCRIPTION

Generally speaking, pursuant to various embodiments, systems and methods are provided for receiving, from unmanned vehicles, packages containing products ordered by customers in secure receptacles, and for dispensing the packages from the receptacles.

In some embodiments, a receptacle for receiving, from unmanned vehicles, packages containing products ordered by customers, and for dispensing the packages therefrom comprises a movable access panel configured to move, from a closed position that restricts access to an interior of the receptacle, to an open position that permits a product-containing package being dropped off by an unmanned vehicle to be deposited into a first storage compartment located in the interior of the receptacle. The first storage compartment is configured to retain the package deposited therein as a result of movement of the access panel into the open position. The first storage compartment includes a customer access opening restricted by a movable cover configured to open, in response to the customer entering an access code, and to permit the customer to retrieve the package from the first storage compartment though the customer access opening. The first storage compartment further includes a release panel movable from a closed position that retains the package in the first storage compartment to an open position that releases the package from the first storage compartment into a second storage compartment located in the interior of the receptacle. The second storage compartment is separated from the first storage compartment by the release panel and including a delivery service access opening restricted by a movable cover configured to open and permit a delivery service operator to retrieve the package from the second storage compartment through the delivery service access opening. The receptacle further includes a control unit including a processor and operatively coupled to the release panel, the control unit being programmed to cause the release panel to move from the closed position to the open position after a predefined interval of time of the package being retained in the first storage compartment without being retrieved by the customer

In some embodiments, a method of receiving in receptacles, from unmanned vehicles, packages containing products ordered by customers, and for dispensing the packages to the customers from the receptacles, comprises: moving a movable access panel of the receptacle from a closed position that restricts access to an interior of the receptacle, to an open position that permits a product-containing package being dropped off by an unmanned vehicle to be deposited into a first storage compartment located in the interior of the receptacle, retaining the package in the first storage compartment after the package is deposited into the first storage compartment as a result of movement of the access panel into the open position; providing the first storage compartment with a customer access opening restricted by a movable cover; opening the movable cover of the first storage compartment in response to the customer entering an access code and permitting the customer to retrieve the package from the first storage compartment though the customer access opening; providing the first interior compartment with a release panel movable from a closed position that retains the package in the first storage compartment to an open position that releases the package from the first storage compartment into a second storage compartment located in the interior of the receptacle; providing the second storage compartment with a delivery service access opening restricted by a movable cover configured to open and permit a delivery service operator to retrieve the package from the second storage compartment through the delivery service access opening; providing a control unit including a processor and operatively coupled to the release panel; and causing, via the control unit, the release panel to move from the closed position to the open position after a predefined interval of time of the package being retained in the first storage compartment without being retrieved by the customer.

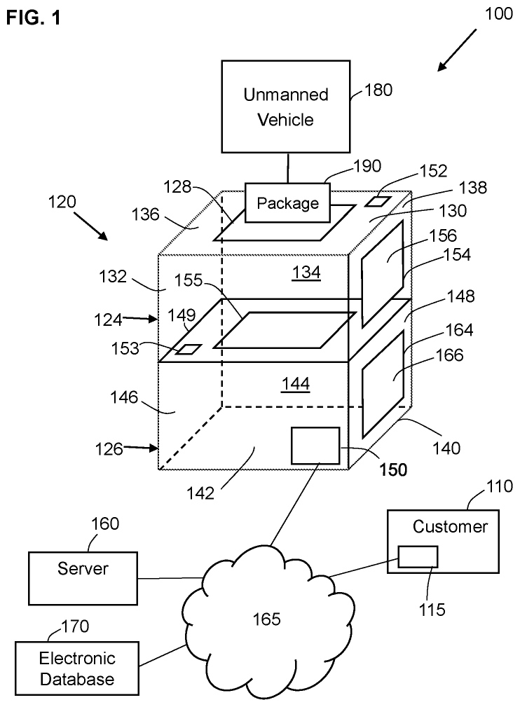

FIG. 1 shows one embodiment of a system 100 including a receptacle 120 for receiving and storing packages 190 containing products ordered by customers 110 from a retail provider and for dispensing the packages 190 stored therein (e.g., to the customers 110, to delivery service personnel, etc.) The retail provider may be any place of business having a brick-and-mortar physical location and/or a website accessible via the internet through which products may be ordered by or for the customer 110.

In the embodiment illustrated in FIG. 1, the receptacle 120 comprises a plurality of interconnected panels that enclose one or more interior compartments each configured to retain the packages 190 deposited into the receptacle 120. In the embodiment shown in FIG. 1, the interior of the exemplary receptacle 120 is divided into two compartments, a first storage compartment 124 and a second storage compartment 126. It will be appreciated that the receptacle 120 has been illustrated as having two interior storage compartments 124, 126 by way of example only, and that the receptacle 120 may include three, four, or more compartments in other embodiments. Each of the first and second storage compartments 124, 126 is sized and shaped to retain one or more product-containing packages 190 deposited into the interior of the receptacle 120. Exemplary products that may be deposited into the receptacle 120 in the packages 190 may include, but are not limited to general-purpose consumer goods as well as consumable items (e.g., food items, dietary supplements, medications, or the like).

While the exemplary receptacle 120 of FIG. 1 is shown as a single receptacle having two interior storage compartments 124 and 126 each configured to store a single package 190, in some embodiments, the receptacle 120 may be configured as a modular receptacle the comprises two or more receptacles identical to the receptacle 120 coupled to each other. The modular nature of the receptacle 120 advantageously increases the storage capacity of the receptacle 120, enabling a modular embodiment of the receptacle 120 to simultaneously securely store two or more packages 190 for pick up by two or more customers 110 of the retail provider. In some embodiments, a modular receptacle may include two or more movable access panels configured to provide access to respective ones of a plurality of first storage compartments, where the packages 190, once deposited, may be secured stored for pick up by the customer 110. In one aspect, a modular receptacle may include one or more transmitters coupled to one or more of the movable access panels 128 and configured to transmit one or more signals to the unmanned vehicles 180 indicating which ones of the first storage compartments 124 are available for dropping off the packages 190 via movement of the respective one of the access panels 128.

In some aspects, each of the first and second storage compartments 124 and 126 may include vertical partition panels that divide each of the first and second storage compartments 124 and 126 into two or more (e.g., 3, 4, 5, 6, etc.) smaller compartments each configured to retain one or more product-containing packages 190. The subdivision of the first and second storage compartments 124 and 126 may be useful in situations, where the receptacle is used to retain packages 190 associated with multiple different customer orders for pick up by different customers 110, thereby providing a customer 110 with access to only one sub-compartment (where his or her packages 190 are retained) while not providing the customer 110 with access to any of the other sub-compartments (which retain packages 190 for other customers 110). In such embodiments, the access panel 128 may be configured in the form of multiple access sub-panels each aligned with their respective sub-compartments such that movement of each of the sub-panel results in a package 190 to drop into its respective sub-compartment.

In some embodiments, the receptacle 120 is configured such that the first storage compartment 124 is configured to store product-containing packages 190 dropped off (i.e., deposited) by an unmanned vehicle (e.g., a UAV, AGV, or the like), and the second storage compartment 126 is configured to store product-containing packages 190 that were transferred from the first storage compartment 124 and are being retained in the second storage compartment 126 for pick up by a product delivery service worker (or an unmanned vehicle).

In the embodiment illustrated in FIG. 1, the first storage compartment 124 of the exemplary receptacle 120 comprises multiple exterior panels including a top-most panel 130, a front-facing panel 132, a rear-facing panel 134, a first side panel 136, and a second side panel 138. The second storage compartment 126 of the exemplary receptacle 120 also comprises multiple exterior panels including a bottom-most panel 140, a front-facing panel 142, a rear-facing panel 144, a first side panel 146, and a second side panel 148. In the illustrated embodiment, the first and second storage compartments 124 and 126 are separated by a partition panel 149, which forms the bottom-most panel of the first storage compartment 124 and the top-most panel of the second storage compartment 126.

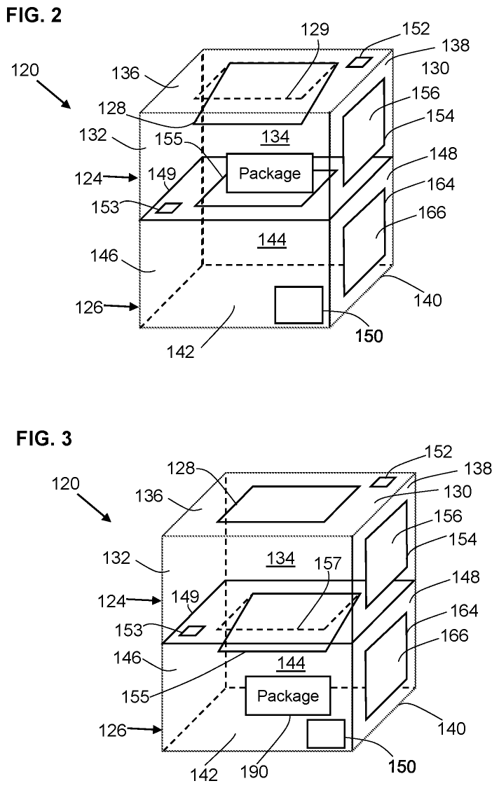

In order to permit product-containing packages 190 to be deposited (e.g., by unmanned vehicles or delivery service workers) into the first storage compartment 124, the first storage compartment 124 includes an access panel 128 that is movable from a closed position obstructing access to the interior of the first storage compartment 124 to an open position providing access for one or more packages 190 being deposited into the interior of the first storage compartment 124. In some embodiments, the access panel 128 is configured such that movement of the access panel 128 from the closed position (shown in FIG. 1) into the open position (shown in FIG. 2) permits the product-containing package 190 to be deposited into the first storage compartment 124 and retained therein.

In the illustrated embodiment, the access panel 128 is shown as being located in the top-most panel 130 of the receptacle 120, but it will be appreciated that in some embodiments, the receptacle 120 may be configured such that the movable access panel 128 is formed in any of the other panels (e.g., front-facing panel 132, rear-facing panel 134, first side panel 136, or second side panel 138) of the receptacle 120 that enclose the first storage compartment 124. It will also be appreciated that while the top-most panel 130 is illustrated in FIG. 1 as including a separate movable access panel 128 (having a surface area less than the surface area of the top-most panel 130), in some embodiments, the entire top-most panel 130 may be configured as an access panel such that the entire top-most panel 130 moves from a closed position obstructing access to the interior of the first storage compartment 124 to an open position providing access for one or more packages 190 being deposited into the interior of the first storage compartment 124

With reference to FIG. 1, in order to permit product-containing packages 190 to be deposited (e.g., by unmanned vehicles or delivery service workers) into the first storage compartment 124 of the exemplary receptacle 120, the access panel 128 may be configured to move relative to the top-most panel 130 via one or more spring-loaded mechanisms (e.g., hinges, swivel, pivot, or the like). In one aspect, the access panel 128 is configured to move from the closed position into the open position and permit the package 190 to be deposited into the first storage compartment 124 in response to a force exerted by the weight of the package 190 being dropped off onto the upper-facing surface of the access panel 128 (e.g., by an unmanned vehicle 180). For example, in some aspects, the access panel 128 is configured to move from the closed position to the open position due to a force exerted by the package 190 placed on the upper-facing surface of the access panel 128. In some aspects, the access panel 128 may be spring-biased to move from the closed position into the open position in response to a package 190 meeting or exceeding a predefined weight (e.g., 1 pound, 2 pounds, 3 pounds, or more) being placed onto the access panel 128. To that end, in some embodiments, depending on the weight of the products that are packed into a given package 190, one or more weights may be added to the package 190 such that the overall weight of the package 190 meets or exceeds the minimum predefined weight required in order to exert sufficient to open the access panel 128 when the package is placed onto the access panel 128 during a drop-off by an unmanned vehicle 180.

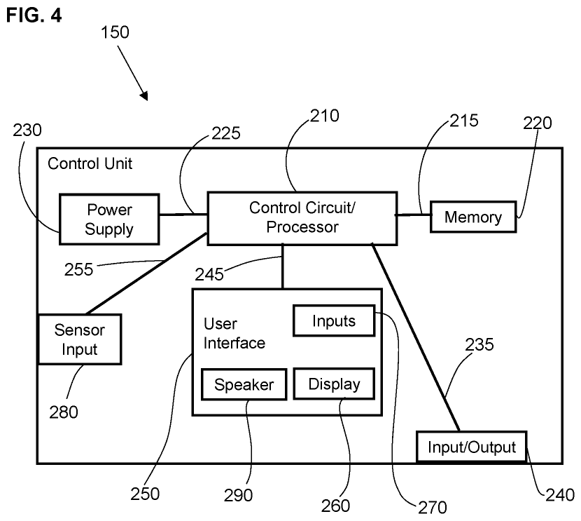

In the illustrated embodiment, the receptacle 120 includes a processor-based control unit 150 (e.g., microcontroller) configured for communication with other electronic devices of the receptacle to facilitate various functions of the receptacle 120 as will be described in more detail below. With reference to FIG. 4, an exemplary control unit 150 configured for use with the system 100 and methods described herein is an electronic computing device including a control circuit 410 including a processor (for example, a microprocessor or a microcontroller) electrically coupled via a connection 415 to a memory 420 and via a connection 425 to a power supply 430. The control circuit 410 of the control unit 150 is also electrically coupled via a connection 435 to an input/output 440 that can receive signals from server 160 (e.g., verification data from the electronic database 170) or from any other source that can communicate with the control unit 150 (e.g., mobile electronic device 115 (e.g., smart phone, tablet, etc.) of a customer 110) via the network 165. The input/output 440 of the control unit 150 can also send signals to the server 160 (e.g., electronic data including a verification input provided by the customer 110 via the mobile electronic device 115 of the customer 110), or to any other device in communication with the control unit 150.

In an embodiment (as in FIG. 1) where the product proximity sensor 152 and the package detecting sensor 153 and the control unit 150 are implemented as physically distinct units in communication with each other, the control unit 150 in FIG. 2 includes sensor inputs 480 configured to receive signals from the separate sensors. For example, the sensor input 480 of the control unit 150 may be configured to receive electronic data from a motion-detecting sensor, a photo sensor, a radio frequency identification (RFID) sensor, an optical sensor, a barcode sensor, a digital camera sensor, a weight sensor, a spectrometric sensor, or the like.

In the embodiment shown in FIG. 2, the control circuit 410 of the control unit 150 is electrically coupled via a connection 445 to a user interface 450, which may include a visual display or display screen 460 (e.g., LED screen) and/or inputs 470 that provide the user interface 450 with the ability to permit a customer 110 to manually communicate with the control unit 150, e.g., by inputting information (e.g., verification data or the like) via touch-screen and/or button operation and/or voice commands to, for example, enable the control unit 150 to authenticate the customer 110 attempting to gain access to the package 190 stored in the first storage compartment 124 of the receptacle 120.

In some embodiments, the display screen 460 of the control unit 150 is also configured to permit the user to see various graphical interface-based menus, options, and/or alerts that may be displayed to the customer 110 by the control unit 150 in connection with the customer 110 attempting to gain access to the package 190 stored in the first storage compartment 124 of the receptacle 120. It will be appreciated that the display screen 460 may, in some embodiments, be configured as both a display screen and an input 470 (e.g., a touch-screen that permits the customer 110 to press directly on the display screen 460 to enter text and/or execute commands.)

The user interface 450 of the control unit 150 may also include a speaker 490 that may provide audible feedback (e.g., alerts) to the customer 110. For example, in some embodiments, the control unit 150 may be programmed to generate an audible query to the consumer via the speaker 490, prompting the customer 110 to verbally speak the verification code (e.g., provided to the customer by the server 160) in order to enable the verification of the identity of the customer 110, and to permit the customer 110 to gain access to the first storage compartment 124 via movement of the customer access opening 154 (the movable cover 156 of which is moved in some embodiments by a signal sent by the control unit 150 after the customer 110 is verified).

In some embodiments, the input/output 440 of the control unit 150 is a transmitter configured to transmit (e.g., over the network 165) a signal to the server 160 including the verification code provided by the customer 110, after which the server 160 queries the electronic database 170 to determine whether the verification code stored in the electronic database 170 in association with the customer 110 matched the verification code provided by the customer 110.

In some embodiments, the receptacle 120 is configured such that placement of the package 190 into direct contact with the upper-facing surface of the access panel 128 is not required in order to cause the access panel 128 to move from the closed position to the open position and permit the package 190 to drop into the first storage compartment 124. Instead, the receptacle 120 according to some embodiments includes a package proximity sensor 152 configured to detect a proximity of the package 190 being dropped off (e.g., by the unmanned vehicle 180, delivery service worker, etc.), and the receptacle 120 is configured such that, in response to the package proximity sensor 152 detecting a proximity of the product-containing package 190, the access panel 128 moves from the closed position into the open position and allows the product-containing package 190 to be deposited into the first storage compartment 124 through an access opening 129 provided by the movement of the access panel 128 from the closed position to the open position.

In the exemplary receptacle 120 illustrated in FIG. 1, the package proximity sensor 152 is coupled to an exterior surface of the top-most panel 130 of the receptacle 120. It will be appreciated that the package proximity sensor 152 may be coupled to any surface (e.g., interior or exterior) of any panel of the receptacle 120. The package proximity sensor 152 may be detachably attached to the top-most panel 130 (or another panel of the receptacle 120) such that the package proximity sensor 152 may be detached from the receptacle 120 when desired. Alternatively, the package proximity sensor 152 may be attached to the top-most panel 130 (or another panel of the receptacle 120), such that the package proximity sensor 152 may not be detached from the top-most panel 130 without damaging the top-most panel 130 and/or the package proximity sensor 152. It will be appreciated that the location of the package proximity sensor 152 is shown in FIG. 1 by way of example only, and that the package proximity sensor 152, instead of being coupled to a panel of the receptacle 120 as shown in FIG. 1, may be coupled to a structure (e.g., wall, post, etc.) positioned proximate to the receptacle 120, such that the package proximity sensor 152 does not directly contact any portion of the receptacle 120, but is positioned to detect the proximity of the packages 190 being dropped off into the receptacle 120.

The package proximity sensor 152 may be a motion-detecting sensor, a photo sensor, a radio frequency identification (RFID) sensor, an optical sensor, a barcode sensor, a digital camera sensor, or a spectrometric sensor. In one embodiment, the package proximity sensor 152 includes a digital camera sensor configured to snap a still photo or record a moving video of the package 190 during the movement of the package 190 toward the access panel 128, and to transmit a signal including the still photo and/or the moving video of the package 190 to a control unit 150 (discussed in more detail below) which then enables the control unit 150 to determine whether the package 190 will fit through the access opening 129 provided by the movement of the access panel 128 of the receptacle 120 from the closed position to the open position.

In some embodiments, the package proximity sensor 152 includes a first sensor configured to detect movement of a package 190 toward the access panel 128 (e.g., by an unmanned vehicle 180 a person, etc.), and a second sensor configured to scan the overall shape of the package 190 and/or scan identifying indicia 192 located on the package 190 when the package 190 is located proximate the access panel 128 and/or otherwise within the detecting range of the package proximity sensor 152. In one exemplary embodiment, the first sensor is configured to activate the second sensor in response to detection, by the first sensor, of the movement of the package 190 toward the access panel 128 of the receptacle 120, such that the second sensor may be inactive until being activated by the first sensor, which conserves battery power that would be consumed if the second sensor were on constantly. In some embodiment, the receptacle 120 may be coupled to one or more solar panels to enable solar-based charging of the electronic components (e.g., sensors, control unit, etc.) of the receptacle 120.

With reference to FIG. 2, after the product-containing package 190 is deposited into the first storage compartment 124 via movement of the access panel 128 from the closed position to the open position as described above, the package 190 dropped into the first storage compartment 124 through the access opening 129 (unobstructed during movement of the access panel 128 from the closed position to the open position) is prevented from falling all the way down into the second storage compartment 126. Instead, the package 190 is retained in the interior of the first storage compartment 124 because the first storage compartment 124 and the second storage compartment 126 are separated by a partition panel 149 on which the product-containing package 190 drops after being deposited through the access opening 129 provided by movement of the access panel 128. In some aspects, the package 190 is retained in the first storage compartment 124 until it is retrieved by a customer 110 (or a person authorized by the customer to pick up the package 190 from the receptacle 120). In order to facilitate retrieval of the product-containing package 190 from the receptacle 120, the receptacle 120 of FIG. 1 includes a customer access opening 154 obstructed by a movable cover 156.

In some aspects, the movable cover 156 opens in response to the customer 110 entering verification data (e.g., into an interface provided on the receptacle or via a mobile electronic device 115 of the consumer) and permits the customer 110 to retrieve the package 190 from the first storage compartment 124 though the customer access opening 154. In particular, in some embodiments, the receptacle 120 is configured to, in response to either a control signal from the control unit 150, or a verification input (e.g., verification code, biometric scan, verbal password, or the like) entered by the customer 110, to permit the customer 110 to retrieve one or more packages 190 from the first storage compartment 124 of the receptacle 120.

The exemplary system 100 shown in FIG. 1 includes a server 160 in two-way communication with the control unit 150 of the receptacle 120 via a network 165. The server 160 may be implemented as one server at one location (e.g., at the retail provider's brick-and-mortar retail facility or at a location specifically dedicated to storage of retail provider's website servers). Alternatively, the server 160 may be implemented as multiple interconnected servers stored at one or more locations. While the control unit 150 and the server 160 have been illustrated in the exemplary embodiment shown in FIG. 1 as two distinct devices in two distinct locations, in some embodiments, the control unit 150 and the server may be integrated into a single computing device, and this computing device may either be directly coupled to the receptacle 120 akin to the control unit 150 in FIG. 1, or may be located remotely to the receptacle 120 akin to the server 160. The network 165 may be a wide-area network (WAN), a local area network (LAN), a personal area network (PAN), a wireless local area network (WLAN), or any other internet or intranet network, or combinations of such networks. Generally, communication between various electronic devices of system 100 may take place over hard-wired, wireless, cellular, Wi-Fi or Bluetooth networked components or the like. In some embodiments, one or more electronic devices of system 100 may include cloud-based features, such as cloud-based memory storage.

In the embodiment shown in FIG. 1, the server 160 may include an electronic database 170. The electronic database 170 may be configured to store information associated with customers 110 of the retail provider who order products from the retail provider (e.g., personal information of the customer 110s, product order history (including product pick-up settings) of the customers 110, and/or authentication information relating to the customers 110). It will be appreciated that the electronic database 170 may further include electronic data including but not limited to: information associated with all orders being fulfilled via the system 100, information associated with the number of and/or locations of all unmanned vehicles 180 transporting the packages 190, as well as information associated with real time locations of the packages 190 (e.g., while being transported by the unmanned vehicles 180 and/or while being retained in the receptacles 120).

While the server 160 is illustrated in FIG. 1 as being in communication with one electronic database 170, it will be appreciated that the system 100 may be implemented such that the server 160 may be connected over the network 165 to two or more separate electronic databases (e.g., one electronic database configured to store customer information, one electronic database configured to store unmanned vehicle information, and/or one electronic database configured to store product inventory information, etc.) The electronic database 170 may be stored, for example, on non-volatile storage media (e.g., a hard drive, flash drive, or removable optical disk) internal or external to the server 160, or internal or external to other computing devices.

In some embodiments, the receptacle 120 includes a transceiver 158 configured to transmit a verification input entered by the customer 110 (e.g., via an interface provided at the receptacle 120 or the mobile electronic device 115 of the customer 110) over the network 165 to the server 160, and the server 160 is configured to authenticate the customer 110 based on the verification input received by the server 160 from the transceiver 158 of the receptacle 120. In some aspects, the server 160 is configured to transmit an access signal to the control unit 150 of the receptacle 120 indicating that the verification input entered by the customer 110 was accepted, and the control unit 150 of the receptacle 120, in response to receipt of the access signal from the server 160, is configured to unlock the movable cover 156 and to permit the customer 110 to retrieve the package 190 from the interior of the receptacle 120 through the customer access opening 154. In some aspects, the verification data (e.g., verification code) to be entered by the customer 110 is transmitted to the mobile electronic device 115 of the customer 110, either directly from the server 160, or from the server 160 via the transceiver 158. The verification data transmitted to the mobile electronic device 115 of the customer 110 may be used by the customer 110 to transmit the verification code to the control unit 150 of the receptacle 120 (e.g., by keying the verification code directly into an interface of the receptacle 120 or by transmitting the verification code from the mobile electronic device 115 of the customer 110) in order to open the movable cover 156 directly, or to open a box that contains a key (physical keys or blockchain-encoded devices) that can open the movable cover 156. The transmission of a verification code to a mobile electronic device 115 of the customer 110 further increases the security of the system 100, and reduces the chance that a person who is not authorized by the customer 110 retrieves the package 190 from the receptacle 120.

According to some embodiments, the transceiver 158 of the receptacle 120 is also configured to transmit, via the network 165, a signal over the network 165 to the server 160 including an electronic confirmation that the package 190 has been retrieved by the customer 110 from the first storage compartment 124 of the receptacle 120 via the customer access opening 154 after the movable cover 156 moves to the open position. In some approaches, in response to receipt of such an electronic confirmation from the receptacle 120, the server 160 is configured to transmit a signal to the electronic database 170 indicating that the order placed by the customer 110 has been completed, thereby updating the electronic database 170 such that the pending order associated with the customer is converted into a completed order.

As described above, in some embodiments, the package 190 is retained in the first storage compartment 124 of the receptacle 120 until a time when the package 190 is retrieved by the customer 110 from the first storage compartment 124 via the customer access opening 154. In certain situations, customers 110 are not able (or choose not to) pick up the packages 190 from the receptacle 120 on the day the packages 190 were first deposited, or at all. Accordingly, in some embodiments, the receptacle 120 is configured such that the package 190 remains in the first storage compartment 124 of the receptacle only for a predetermined period of time (e.g., 30 minutes, 1 hour, 2, hours, 3 hours, 4 hours, 6 hours, 12 hours, 24 hours, 48 hours, 72 hours, etc.), after which the package 190 is automatically transferred from the first storage compartment 124 to the second storage compartment 126 of the receptacle 120. As such, the interior of the first storage compartment 124 is freed to receive other packages 190 instead of holding a package 190 that a customer has not picked up after the predetermined package pick-up time period has expired.

In some aspects, when the presence of the package 190 in the first storage compartment 124 does not prevent a drop off of another package 190 (e.g., by an unmanned vehicle 180) at the receptacle 120, the package 190 is retained in the first storage compartment 124 of the receptacle 120 and is not automatically transferred to the second storage compartment 126 even after the predetermined period of time (e.g., 30 minutes, 1 hour, 2, hours, 3 hours, 4 hours, 6 hours, 12 hours, 24 hours, 48 hours, 72 hours, etc.) expires. In other words, in some aspects, the package 190 is automatically transferred from the first storage compartment 124 to the second storage compartment 126 of the receptacle 120 only when the first storage compartment 124 is required to be freed from the presently stored package 190 (that the customer 110 has not picked up within an allotted period of time) in order to receive other packages 190 that are being dropped off at the receptacle 120 by an unmanned vehicle 180 and that require the storage space of the first storage compartment 124. In one aspect, when a package 190 is retained in the first storage compartment 124 in excess of the predetermined period of time for pick-up of the package 190 by the customer 110, but does not prevent an unmanned vehicle 180 from dropping off another package 190 at the receptacle 120, the package 190 is retained in the first storage compartment 124 of the receptacle 120 and is not automatically transferred to the second storage compartment 126, but the receptacle 120 is marked by the system 100 as being available for drop-off of packages 190 by the unmanned vehicles 180 that are actively en route or about to be deployed.

In one aspect, when the control unit 150 of the receptacle 120 transmits a query (e.g., to the server 160 or electronic database 170) regarding orders being actively fulfilled by the system 100 and receives a signal (e.g., from the server 160 or an unmanned vehicle 180) indicating that no unmanned vehicle 180 is en route to drop off a package 190 at the receptacle 120, the control unit 150 does not cause the package 190 being retained in the first storage compartment 124 to be transferred to the second storage compartment 126 even if the predetermined period of time for pick-up of the package 190 by the customer 110 has expired. Conversely, when the control unit 150 of the receptacle 120 transmits a query (e.g., to the server 160 or electronic database 170) regarding orders being actively fulfilled by the system 100 and receives a signal (e.g., from the server 160 or an unmanned vehicle 180) indicating that there is an unmanned vehicle 180 actively en route to drop off a package 190 at the receptacle 120, the control unit 150 causes (as described in more detail below) the package 190 being retained in the first storage compartment (after the predetermined period of time for pick-up of the package 190 by the customer 110 has expired 124) to be transferred to the second storage compartment 126.

In some embodiments, the receptacle 120 includes a package detecting sensor 153 configured to detect a presence of the package 190 dropped off by the unmanned vehicle 180 in the interior of the first storage compartment, 124. The package detecting sensor 153 may be a motion-detecting sensor, a photo sensor, a radio frequency identification (RFID) sensor, an optical sensor, a barcode sensor, a digital camera sensor, a weight sensor, a spectrometric sensor, or the like. In one embodiment, the package detecting sensor 153 includes a digital camera sensor configured to snap a still photo or record a moving video of the package 190 during the movement of the package 190 within the interior of the first storage compartment 124, and to transmit a signal including the still photo and/or the moving video of the package 190 to the control unit 150, which enables the control unit 150 to determine whether the package 190 is present in the interior of the first storage compartment 124 of the receptacle. In some aspects, the receptacle includes a visual (e.g., light-based), audio (e.g., voice-based), and/or electronic (e.g., signal-based) indicator that indicates (e.g., to an unmanned vehicle 180 and/or a delivery service worker) that the first storage compartment 124 of the receptacle 120 is occupied and cannot accept any more packages 190.

In some embodiments, the control unit 150 is configured to obtain sensor data from the package proximity sensor 152, and in response to receiving a signal from the package proximity sensor 152 indicating that the package 190 is located near the access panel 128 (e.g., being lowered onto the access panel 128 by an unmanned vehicle 180), the control unit 150 is programmed to cause the access panel 128 to move from the closed position of FIG. 1 into the open position of FIG. 2 and permit the package 190 to be deposited into the first storage compartment 124. In some aspects, the control unit 150 is configured to identify the size of the package 190 based on the still photo or moving video acquired by the digital camera of the package proximity sensor 152, and to determine whether the package 190 is sized and shaped such that it will fit into the first storage compartment 124 of the receptacle 120 through the access opening 129 provided by the movement of the access panel 128 from the closed position into the open position.

In some embodiments, as mentioned above, the control unit 150 is programmed, in response to receiving a signal from the package proximity sensor 152, to cause the access panel 128 to move from the closed position into the open position and permit the package 190 to be deposited into the first storage compartment 124 of the receptacle 120. For example, in some aspects, the access panel 128 is operatively coupled to an actuator (e.g., an electric motor, hook and spring-based device, or the like) that, when activated, causes the access panel 128 to pivot, slide, or otherwise move between the closed position and the open position transceiver in response to receiving a signal from the control unit 150.

In some embodiments, the control unit 150 is configured to obtain sensor data from the package detecting sensor 153, and in response to receiving a signal from the package detecting sensor 153 that indicates that the package 190 has been deposited into the first storage compartment 124, to start a timer, and to end the timer when the predefined interval of time is reached. The timer may depend on the specifics of the order placed by the customer 110, and could be, for example, 1 hour, 2 hours, 3 hours, 4 hours, 5 hours, 6 hours, 12 hours, 24 hours, etc. While FIG. 1 shows the control unit 150 and the package proximity sensor 152 and the package detecting sensor 153 are shown as three separate and distinct physical units, it will be appreciated that the control unit 150 may be configured as one physical unit incorporating one or both of the package proximity sensor 152 and/or the package detecting sensor 153.

As discussed above, in the illustrated embodiment, the first and second storage compartments 124 and 126 are separated from each other by the partition panel 149. In the illustrated embodiment, the partition panel 149 comprises a release panel 155 movable from a closed position that retains the package 190 in the first storage compartment 124 to an open position that releases the package 190 from the first storage compartment 124 into the second storage compartment 126 in the interior of the receptacle 120. As mentioned above, in some aspects, the control unit 150 is programmed to cause the release panel 155 to move from the closed position of FIG. 2 to the open position of FIG. 3 after a predefined interval of time of the package 190 being retained in the first storage compartment 124 without being retrieved by the customer 110, such that the package 190 drops form the first storage compartment 124 into the second storage compartment 126 through the opening 157 crated by the movement of the release panel 155 from the closed position to the open position. As discussed above, in some embodiments, the control unit 150 does not cause the package 190 being retained in the first storage compartment 124 to be transferred to the second storage compartment 126 even if the predetermined period of time for pick-up of the package 190 by the customer 110 has expired in situations, where the control unit 150 transmits a query (e.g., to the server 160 or electronic database 170) regarding orders being actively fulfilled by the system 100 and receives a notification signal (e.g., from the server 160 or an unmanned vehicle 180) indicating that no unmanned vehicle 180 is en route to drop off a package 190 at the receptacle 120. By the same token, in some aspects, the control unit 150 causes the package 190 being retained in the first storage compartment (after the predetermined period of time for pick-up of the package 190 by the customer 110 has expired 124) to be transferred to the second storage compartment 126 (by way of causing the release panel 155 to move from the closed position to the open position) in situations, where the control unit 150 transmits a query (e.g., to the server 160 or electronic database 170) regarding orders being actively fulfilled by the system 100 and receives a notification signal (e.g., from the server 160 or an unmanned vehicle 180) indicating that there is an unmanned vehicle 180 actively en route to drop off a package 190 at the receptacle 120.

Unlike the first storage compartment 124 of the receptacle 120, which may be accessed only by the customer 110 who ordered the products contained in the package 190, the second storage compartment 126 of the receptacle 120 may be accessed only by the delivery service workers (or other authorized personnel) to retrieve the package 190 from the receptacle 120 when the package 190 has not been timely picked up by the customer 110, and to either deliver the package 190 to the customer 110 via other means (e.g., delivery truck, unmanned vehicle, etc.), or to return the package 190 to a facility of the retail provider, after which the order is cancelled.

In the embodiment illustrated in FIG. 1, to permit a delivery service operator to retrieve the package 190 from the second storage compartment 126, the second storage compartment 126 includes a delivery service access opening 164 restricted by a cover 166 that is configured to move from a closed position where it restricts access to the interior of the second storage compartment 126 through the delivery service access opening 164 to an open position where it permits access to the interior of the second storage compartment 126 through the delivery service access opening 164. In some embodiments, the movable cover 166 restricting access to the delivery service access opening 164 is configured to be unlocked by the delivery service operator via means including but not limited to: verification input (e.g., access code, biometric data, or the like), a physical key, or the like.

Since the receptacles 120 are located outside and exposed to the elements (e.g., sun, rain, snow, etc.), in some embodiments, the receptacle 120 may be coupled to a cover (e.g., roof, umbrella, etc.) that would protect a consumer interacting with the receptacle 120 from the elements. During rain, it is conceivable that rain water may go into the interior of the first storage compartment 124 through the access opening 129 as a result of the movement of the access panel 128 from the closed position to the open position when permitting the package 190 to drop into the interior of the first storage compartment 124. To address this potential issue, in some embodiments, the receptacle 120 includes at least one drainage pipe positioned such that it traps the rain water that enters the interior of the receptacle 120 as a result of movement of the access panel 128 from the closed position to the open position, and guides the trapped rain water out of the interior of the receptacle 120 (e.g., via a terminal portion of the drainage pipe, or through a drainage opening in communication with the terminal portion of the drainage pipe). In one aspect, a portion of the drainage pipe may have heating elements coupled thereto in order to provide a heating effect to the fluid and/or particles flowing through the drainage pipe, thereby preventing the rain water flowing through the drainage pipe from freezing and/or melting any snow that may enter the interior of the receptacle 120 as a result of movement of the access panel 128 from the closed position to the open position, and ensure that the snow does not freeze in the drainage pipe.

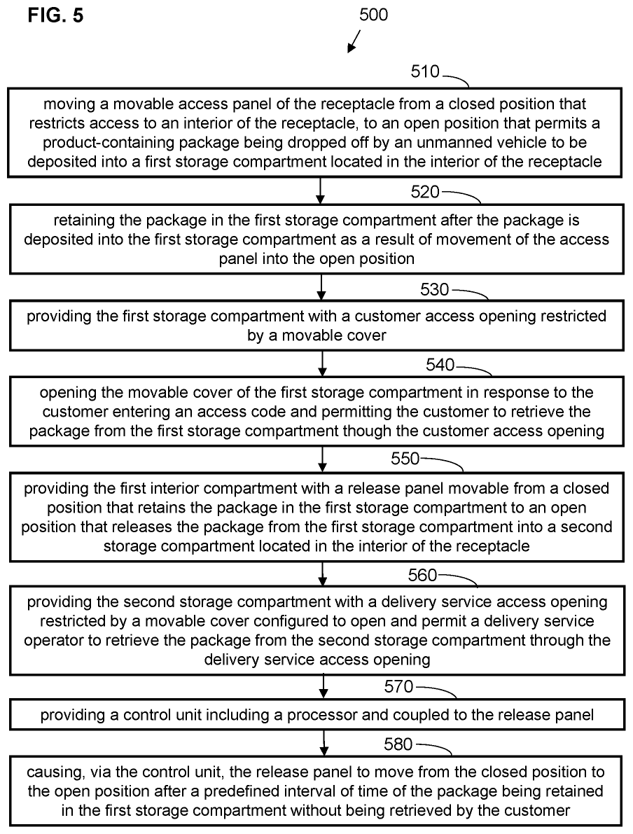

FIG. 5 shows an embodiment of an exemplary method 500 of receiving in receptacles 120, from unmanned vehicles 180, packages 190 containing products ordered by customers, and for dispensing the packages 190 from the receptacles 120. As described above, the receptacle 120 is used to receive and retain package 190 deposited into the receptacle 120 by unmanned vehicles (e.g., UAVs, UGVs, etc.) or delivery service workers. In some embodiments, a package 190 is deposited into a receptacle 120 when an unmanned vehicle or a delivery service worker places the package onto (or otherwise into contact) the access panel 128 of the receptacle 120, and the access panel 128 moves (e.g., in response to the force exerted by the weight of the package 190, or in response to being actuated by an activation signal-controlled motor) in order to permit the product-containing package 190 to be deposited into the first storage compartment 124 of the receptacle 120. To that end, the exemplary method 500 includes moving a movable access panel 128 of the receptacle from a closed position that restricts access to an interior of the receptacle 120, to an open position that permits a product-containing package 190 being dropped off by an unmanned vehicle 180 to be deposited into a first storage compartment 124 located in the interior of the receptacle 120 (step 510).

After the product-containing package 190 is deposited into the first storage compartment 124 via movement of the access panel 128 from the closed position to the open position, the package 190 dropped into the first storage compartment 124 drops onto the partition panel 149 separating the first storage compartment 124 from the second storage compartment 126. In some aspects, the package 190 is then retained in the first storage compartment 124 until it is retrieved by a customer 110 (or a person authorized by the customer to pick up the package 190 from the receptacle 120) via a customer access opening 154 that is generally obstructed by a movable cover 156. To that end, the method 500 of FIG. 5 includes retaining the package 190 in the first storage compartment 124 after the package 190 is deposited into the first storage compartment 124 as a result of movement of the access panel 128 into the open position (step 520), and providing the first storage compartment 124 with a customer access opening 154 restricted by a movable cover 156 (step 530).

In some aspects, a customer 110 who ordered the products contained in the package 190 (or a person authorized by the customer 110) is permitted to attempt to retrieve the package 190 containing the customer-ordered products from the first storage compartment 124 by entering verification data (e.g., verification code, biometric scan, verbal password, or the like). If this verification data entered by the customer 110 (which, in some embodiments, is transmitted to the server 160 for authentication by cross-referencing the information stored in the electronic database 170) is authenticated, in some aspects, the movable cover 156 opens (e.g., in response to a control signal received from the control unit 150) and permits the customer 110 to retrieve the package 190 from the first storage compartment 124 though the customer access opening 154. To that end, the exemplary method 500 of FIG. 5 includes opening the movable cover 156 of the first storage compartment 124 in response to the customer 110 entering an access code and permitting the customer 110 to retrieve the package 190 from the first storage compartment 124 though the customer access opening 154 (step 540).

In the illustrated embodiment, the method 500 of FIG. 5 further includes providing the first storage compartment 124 with a release panel 155 movable from a closed position that retains the package 190 in the first storage compartment 124 to an open position that releases the package 190 from the first storage compartment 124 into a second storage compartment 126 located in the interior of the receptacle 120 (step 550). In particular, as described above, the first and second storage compartments 124 and 126 are separated by a partition panel 149, which is movable from a closed position that retains the package 190 in the first storage compartment 124 to an open position that releases the package 190 from the first storage compartment 124 into the second storage compartment 126 in the interior of the receptacle 120.

The method 500 further includes providing the second storage compartment 124 with a delivery service access opening 164 restricted by a movable cover 166 configured to open and permit a delivery service operator to retrieve the package 190 from the second storage compartment 126 through the delivery service access opening 164 (step 560). In particular, as mentioned above, the second storage compartment 126 includes a delivery service access opening 164 restricted by a cover 166 that is configured to move from a closed position where it restricts access to the interior of the second storage compartment 126 through the delivery service access opening 164 to an open position where it permits access to the interior of the second storage compartment 126 through the delivery service access opening 164. This movable cover 166 restricting access to the second storage compartment 126 via the delivery service access opening 164 is configured to be unlocked by the delivery service operator via electronic verification input (e.g., access code, biometric data, or the like), a physical key, or the like.

Since customers 110 do not always pick up the packages 190 from the receptacle 120 within a reasonable time (e.g., a specific pick-up time specified in the product order, or a pick-up time predefined by the server 160 and/or control unit 150), in some embodiments, the receptacle 120 is configured such that the package 190 remains in the first storage compartment 124 of the receptacle only for a predetermined period of time (e.g., 30 minutes, 1 hour, 2, hours, 3 hours, 4 hours, 6 hours, 12 hours, 24 hours, 48 hours, 72 hours, etc.), after which the package 190 is automatically transferred from the first storage compartment 124 to the second storage compartment 126 of the receptacle 120. In the illustrated embodiment, the receptacle 120 includes a control unit 150 operatively coupled to the release panel 155 such that, after the predetermined period of time during which the package 190 is permitted to remain in the first storage compartment 124 without being picked up elapses, the control unit 150 sends an activation signal to the release panel 155 to cause the release panel 155 to move from the closed position (FIG. 2) to the open position (FIG. 3). As shown in FIG. 3, the movement of the release panel 155 from the closed position to the open position causes the package 190 to drop form the first storage compartment 124 into the second storage compartment 126 through the opening 157 created by the movement of the release panel 155 from the closed position to the open position. To that end, the exemplary method 500 of FIG. 5 includes providing a control unit 150 including a processor 410 and coupled to the release panel 155 (step 570) and causing, via the control unit 150, the release panel 155 to move from the closed position to the open position after a predefined interval of time of the package 190 being retained in the first storage compartment 124 without being retrieved by the customer 110 (step 580).

The systems and methods described herein advantageously provide for simple receptacles configured to receive packages ordered by customers of a retail provider, and to securely store the packages until picked up by the customers. If the customers do not pick up the products within a predefined product pick-up time, the receptacles automatically transfer the packages from the first storage compartment accessible by the customer to a second storage compartment, which is accessible by a delivery service workers, thereby enabling the delivery service workers to retrieve the packages from the receptacles and to either deliver the packages to the customers via other means, or to return the packages to a facility operated by or for the retail provider. As such, the systems and methods described herein provide for simple and cost-efficient package storage receptacles that may be advantageously used by a wide range of communities.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A receptacle for receiving, from unmanned vehicles, packages containing products ordered by customers, and for dispensing the packages therefrom, the receptacle comprising:
a movable access panel configured to move, from a closed position that restricts access to an interior of the receptacle, to an open position that permits a product-containing package being dropped off by an unmanned vehicle to be deposited into a first storage compartment located in the interior of the receptacle,
the first storage compartment being configured to retain the package deposited therein as a result of movement of the access panel into the open position, the first storage compartment including:
a customer access opening restricted by a movable cover configured to open, in response to the customer entering an access code, and to permit the customer to retrieve the package from the first storage compartment though the customer access opening;
a release panel movable from a closed position that retains the package in the first storage compartment to an open position that releases the package from the first storage compartment into a second storage compartment located in the interior of the receptacle;
the second storage compartment being separated from the first storage compartment by the release panel and including a delivery service access opening restricted by a movable cover configured to open and permit a delivery service operator to retrieve the package from the second storage compartment through the delivery service access opening; and
a control unit including a processor and operatively coupled to the release panel, the control unit being programmed to cause the release panel to move from the closed position to the open position after a predefined interval of time of the package being retained in the first storage compartment without being retrieved by the customer.

2. The receptacle of claim 1, further comprising a package proximity sensor configured to detect a proximity of the package being dropped off by the unmanned vehicle, and wherein the control unit is programmed, in response to receiving a package proximity signal from the package proximity sensor, to cause the movable access panel to move from the closed position into the open position and permit the package to be deposited into the first storage compartment.

3. The receptacle of claim 1, wherein the movable access panel is configured to move from the closed position into the open position and permit the package to be deposited into the first storage compartment in response to a weight of the package being dropped off thereon by the unmanned vehicle.

4. The receptacle of claim 1,
further comprising a package detecting sensor configured to detect a presence of the package dropped off by the unmanned vehicle in the interior of the first storage compartment, wherein the control unit is programmed, in response to receiving a signal from the package detecting sensor indicating that the package has been deposited into the first storage compartment, to start a timer, and to end the timer when the predefined interval of time is reached; and
wherein after the predefined interval of time of the package being retained in the first storage compartment without being retrieved by the customer is reached, the control unit does not cause the release panel to move from the closed position to the open position that releases the package from the first storage compartment into the second storage compartment in response to receipt, by the control unit, of a notification indicating that no unmanned vehicle is en route to drop off the package at the receptacle.

5. The receptacle of claim 1, wherein the movable cover restricting access to the customer access opening of the first storage compartment is configured to be unlocked by the customer in response to a verification input by the customer, wherein the verification input comprises at least one of a verification code, a biometric scan, and a verbal password.

6. The receptacle of claim 1, wherein the movable cover restricting access to the delivery service access opening of the second storage compartment is configured to be unlocked by the delivery service operator via at least one of a physical key and a verification input.

7. The receptacle of claim 1, further comprising at least one drainage pipe configured to permit rain that enters the interior of the receptacle as a result of movement of the movable access panel from the closed position to the open position to flow in the drainage pipe and out of the interior of the receptacle.

8. The receptacle of claim 7, wherein at least a portion of the drainage pipe is heated such that snow that enters the interior of the receptacle as a result of movement of the movable access panel from the closed position to the open position is melted and does not freeze in the drainage pipe.

9. The receptacle of claim 1, wherein the receptacle is a modular receptacle configured to be coupled to at least one other identical receptacle.

10. The receptacle of claim 9, wherein the modular receptacle includes a plurality of movable access panels configured to provide access to a respective one of a plurality of first storage compartments, each of the movable access panels including a transmitter indicating to the unmanned vehicle which ones of the first storage compartments are available for dropping off the package via respective one of the movable access panels.

11. A method of receiving in receptacles, from unmanned vehicles, packages containing products ordered by customers, and for dispensing the packages from the receptacles, the method comprising:
moving a movable access panel of the receptacle from a closed position that restricts access to an interior of the receptacle, to an open position that permits a product-containing package being dropped off by an unmanned vehicle to be deposited into a first storage compartment located in the interior of the receptacle,
retaining the package in the first storage compartment after the package is deposited into the first storage compartment as a result of movement of the access panel into the open position;
providing the first storage compartment with a customer access opening restricted by a movable cover;
opening the movable cover of the first storage compartment in response to the customer entering an access code and permitting the customer to retrieve the package from the first storage compartment though the customer access opening;
providing the first interior compartment with a release panel movable from a closed position that retains the package in the first storage compartment to an open position that releases the package from the first storage compartment into a second storage compartment located in the interior of the receptacle;
providing the second storage compartment with a delivery service access opening restricted by a movable cover configured to open and permit a delivery service operator to retrieve the package from the second storage compartment through the delivery service access opening;
providing a control unit including a processor and operatively coupled to the release panel; and
causing, via the control unit, the release panel to move from the closed position to the open position after a predefined interval of time of the package being retained in the first storage compartment without being retrieved by the customer.

12. The method of claim 11, further comprising:
providing a package proximity sensor configured to detect a proximity of the package being dropped off by the unmanned vehicle; and
causing, via the control unit and in response to receiving a package proximity signal from the package proximity sensor, the movable access panel to move from the closed position into the open position and permit the package to be deposited into the first storage compartment.

13. The method of claim 11, further comprising moving the movable access panel from the closed position into the open position and permitting the package to be deposited into the first storage compartment in response to a weight of the package being dropped off onto the movable access panel by the unmanned vehicle.

14. The method of claim 11, further comprising:
providing a package detecting sensor configured to detect a presence of the package dropped off by the unmanned vehicle in the interior of the first storage compartment; and
starting a timer, via the control unit and in response to receiving a signal from the package detecting sensor indicating that the package has been deposited into the first storage compartment;
ending the timer, via the control unit, when the predefined interval of time is reached; and
after the predefined interval of time of the package being retained in the first storage compartment without being retrieved by the customer is reached:
receiving, by the control unit, a notification indicating that no unmanned vehicle is en route to drop off the package at the receptacle; and
not causing, via the control unit, the release panel to move from the closed position to the open position that releases the package from the first storage compartment into the second storage compartment in response to the receipt of the notification.

15. The method of claim 11, further comprising unlocking the movable cover restricting access to the customer access opening of the first storage compartment in response to a verification input by the customer, wherein the verification input comprises at least one of a verification code, a biometric scan, and a verbal password.

16. The method of claim 11, further comprising permitting the movable cover restricting access to the delivery service access opening of the second storage compartment to be unlocked by the delivery service operator via at least one of a physical key and a verification input.

17. The method of claim 11, further comprising providing at least one drainage pipe configured to permit rain that enters the interior of the receptacle as a result of movement of the movable access panel from the closed position to the open position to flow in the drainage pipe and out of the interior of the receptacle.

18. The method of claim 17, further comprising heating at least a portion of the drainage pipe such that snow that enters the interior of the receptacle as a result of movement of the movable access panel from the closed position to the open position is melted and does not freeze in the drainage pipe.

19. The method of claim 11, further comprising configuring the receptacle as a modular receptacle configured to be coupled to at least one other identical receptacle.

20. The method of claim 11, further comprising:
providing the modular receptacle with a plurality of movable access panels configured to provide access to a respective one of a plurality of first storage compartments; and
providing each of the movable access panels with a transmitter indicating to the unmanned vehicle which ones of the first storage compartments are available for dropping off the package via respective one of the movable access panels.
